(19) United States
(12) Patent Application Publication
(10) Pub. No.: US 2011/0061742 A1
(43) Pub. Date: Mar. 17, 2011

(54) CRYOGENIC LIQUID CYLINDER MANIFOLD

(75) Inventors: William Clinton Osteen, Hartselle, AL (US); Mark K. Hamm, Cullman, AL (US)

(73) Assignee: Tyco Valves & Controls LP, Houston, TX (US)

(21) Appl. No.: 12/879,703

(22) Filed: Sep. 10, 2010

Related U.S. Application Data
(60) Provisional application No. 61/241,726, filed on Sep. 11, 2009.

(51) Int. Cl. F17C 13/04; F17C 9/02

(52) U.S. Cl. 137/14; 137/613

(57) ABSTRACT

A cryogenic liquid cylinder pressure control manifold is disclosed. The manifold includes, in a unitary arrangement, a pressure build regulator, a pressure build inlet fitting, a pressure build regulator, NPT adapter fitting, a check valve, and a cylinder pressure gauge. The disclosed manifold eliminates various threaded connections associated with prior devices, thus providing a more reliable device having less likelihood to leak in service. The disclosed manifold also reduces labor costs associated with assembling prior systems which are composed of a plurality of different individual components. In one embodiment, the disclosed manifold is employed as a cryogenic CO₂ manifold for use in the beverage industry.

### CROSS-REFERENCE TO RELATED APPLICATIONS

This is a non-provisional application of pending U.S. provisional patent application Ser. No. 61/241,726, filed Sep. 11, 2009, the entirety of which provisional application is incorporated herein by reference.

### BACKGROUND OF THE INVENTION

1. Field of the Invention

Embodiments of the invention generally relate to the field of cryogenic liquid cylinder pressure control manifolds, and more particularly to a CO₂ cryogenic liquid cylinder pressure control manifold for the beverage industry.

2. Discussion of Related Art

Cryogenic liquids, that is, liquids having a boiling point generally below −150° F. at atmospheric pressure, are used in a variety of applications. Such cryogens are typically stored as liquids, since one volume of liquid produces many volumes of gas (600-900 volumes of gas per one volume of liquid) when the liquid is permitted to vaporize and warm to ambient temperature. In one common use, cylinders filled with liquid carbon dioxide are used to dispense gaseous carbon dioxide for carbonation of beverages.

Such cylinders typically carry a quantity of liquid along with a quantity of gas disposed in the headspace above the liquid. In order to extract the liquid from the cylinder and convert it to a desired gaseous state, a variety of components are typically connected to the cylinder. Such components can include valves, pressure regulators, pressure gauges, seals, and other similar fluid system elements.

One problem with current arrangements is that each of these multiple individual components must each be fabricated, sourced, and assembled into a final operational unit. Each step in this process incurs an associated labor cost. Another problem is that such current arrangements include multiple joints between components. Often these joints are threaded connections, each of which represents a potential leak path. Leakage between components in operation results in a waste of liquid/gas, and also represents additional part and labor costs associated with component replacement and/or repair.

Thus, there is a need for a simplified arrangement for dispensing gas from a cryogenic liquid cylinder. Such a simplified design should reduce the total number of parts required to provide a desired functionality without compromising such functionality.

### SUMMARY OF THE INVENTION

A manifold is disclosed for use in controlling liquid cylinder pressures for liquid or gaseous compositions. In one embodiment, a cryogenic liquid cylinder pressure control manifold is disclosed. In another embodiment, a CO₂ cryogenic liquid cylinder pressure control manifold is disclosed for use in the beverage industry.

The disclosed manifold packages or unitizes a plurality of valves required for liquid cylinder operation into a single unit, thus eliminating the need for labor to purchase and pipe together all the needed valves and components separately. This eliminates typically high labor cost and/or long assembly time, reduces throughput, reduces the number of potential leak paths, and reduces the total number of components required to be assembled.

One manifold body may accommodate a set of necessary valve components, or all valve components, needed for a given assembly. Using a core body component, connections between valves can be made through drilled passageways in this core body component, removing likely leak locations by eliminating multiple threaded connections.

A cryogenic fluid manifold is disclosed. The manifold may comprise a unitary body including first and second pressure regulators, each of said first and second pressure regulators having an inlet and an outlet. The manifold may also include a storage cylinder adapter in fluid communication with the outlet of said first pressure regulator. The manifold may further include a pressure build inlet fitting in fluid communication with the inlet of said first pressure regulator; a final line inlet fitting in fluid communication with an inlet of said second pressure regulator; and a final line outlet fitting in fluid communication with an outlet of said second pressure regulator.

A fluid manifold is further disclosed, comprising a unitary body including a pressure build regulator and a line pressure regulator. The manifold further comprises a pressure build inlet fitting and a pressure build outlet fitting in fluid communication with an inlet and an outlet, respectively, of said pressure build regulator. A final line inlet fitting and a final line outlet fitting are provided in fluid communication with an inlet and an outlet, respectively, of said line pressure regulator. In addition, a relief valve is provided in fluid communication with at least one of the pressure build outlet fitting and the final line inlet fitting.

A method is also disclosed for processing a cryogenic composition, comprising the steps of: providing a cryogenic fluid manifold comprising a unitary body having first and second pressure regulators; receiving fluid from a cryogenic cylinder, regulating said received fluid using the first pressure regulator, and directing the fluid to a headspace region of the cryogenic cylinder to increase pressure in the cryogenic cylinder to a set point of the first pressure regulator; and receiving gas from the headspace of the cryogenic cylinder, regulating said received gas using the second pressure regulator, and directing the regulated gas to a downstream line at a final regulated line pressure.

### BRIEF DESCRIPTION OF THE DRAWINGS

The accompanying drawing illustrates an exemplary embodiment of the disclosed device so far devised for the practical application of the principles thereof, and in which:

FIG. 1 is an isometric illustration of the disclosed cylinder manifold;

FIG. 2 is reverse isometric illustration of the disclosed cylinder manifold of FIG. 1;

FIG. 3 is a cross-sectional illustration of the inside of the disclosed cylinder manifold taken along line 3-3 of FIG. 1;

FIG. 4 is an isometric illustration of an alternative arrangement of the disclosed cylinder manifold; and

FIG. 5 is a reverse isometric illustration of the cylinder manifold of FIG. 4.

### DESCRIPTION OF EMBODIMENTS

A manifold is disclosed for the control of liquid cylinder pressures for liquid or gaseous compositions. In one embodiment, the manifold is a CO₂ cryogenic liquid cylinder pressure control manifold for use in the beverage industry. The manifold packages or unitizes together a plurality of valve components required for liquid cylinder operation into one unit, thus eliminating the need for labor to purchase and pipe together all of the needed valves separately.

The manifold 1 generally comprises a unitary body 3 to which a plurality of fittings, valves and gauges are coupled. The fittings, valves and gauges are interconnected, as will be described in greater detail, via internal passageways that are machined or otherwise formed in the manifold.

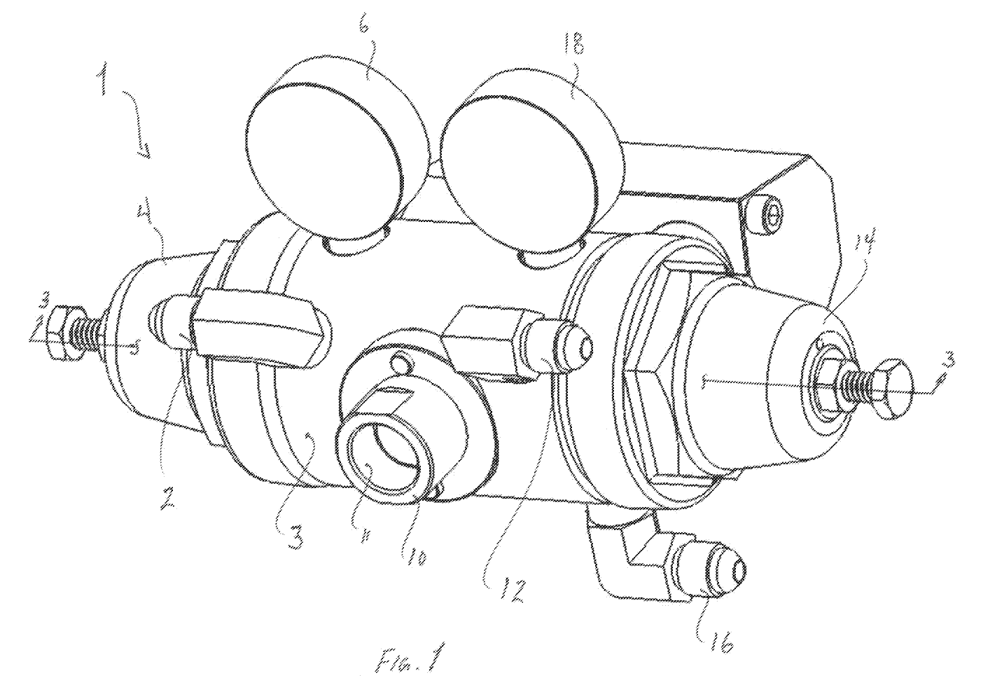

Referring to FIGS. 1-3, the manifold 1 includes a pressure build regulator 4 useful for building pressure in a liquid storage cylinder or tank (not shown). The storage cylinder is attached to the manifold through a pressure build inlet fitting 2, which forms a conduit for the ingress of liquid or gas from the storage cylinder into the manifold. Such liquids or gases may include any cryogenic composition, including for example and without limitation, CO₂, N₂, O₂, Argon, and other like elements or combinations of elements that are normally gaseous at room temperature and pressure, which have been cooled and/or compressed for liquefaction for convenient transport and storage. In one preferred embodiment, the liquid is CO₂.

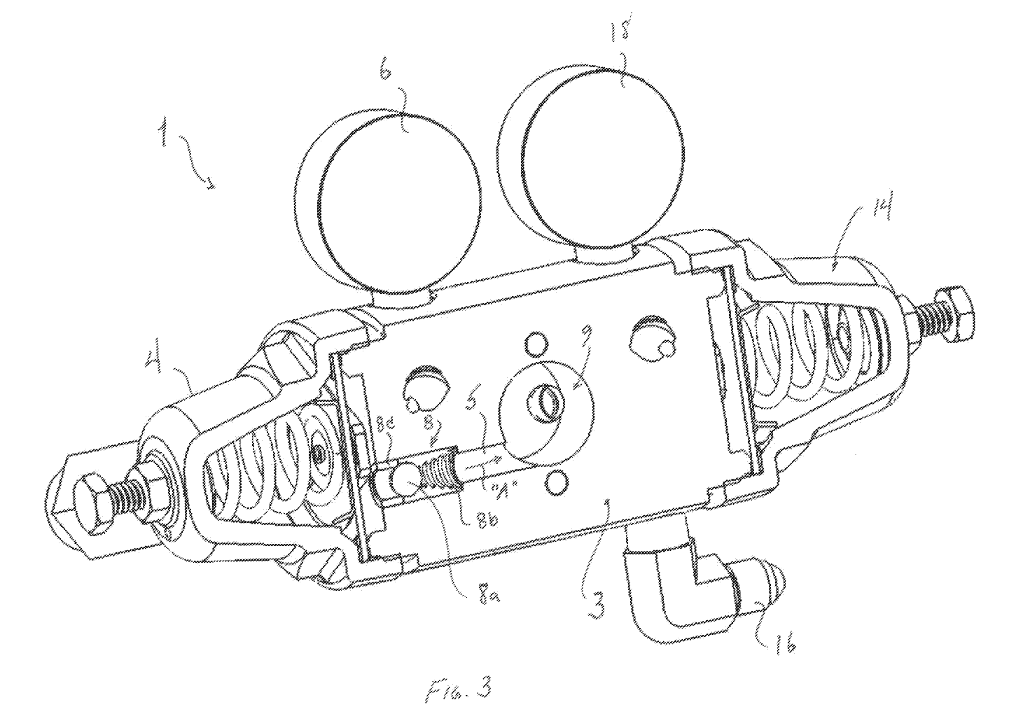

Liquid or gas enters the manifold 1 through a pressure build inlet fitting 2, which is connected to a line that runs to the liquid portion of the storage cylinder. In some embodiments the fluid is drawn from the bottom of the storage cylinder and provided directly to the manifold 1. In other embodiments, liquid drawn from the cylinder may be passed through a vaporizer coil before entering the manifold. From the pressure build inlet fitting 2, the fluid is directed to an inlet of the pressure build regulator 4 via an internal passageway formed in the body 3 of the manifold 1. The pressure build regulator reduces the fluid pressure to the pressure build regulator set pressure. From the outlet of the pressure build regulator 4, the gas enters a check valve 8 (see FIG. 3), traveling in the direction shown as arrow “A.” The check valve 8 enables gas to flow through the body of the manifold, but ensures that fluid does not flow back into the pressure build regulator 4 during maintenance or other operational disconnections.

In the illustrated embodiment, the check valve 8 is a ball-check valve which includes a ball element 8a and a spring 8b for holding the ball element against a valve seat 8c. It will be appreciated that the check valve 8 could be any of a variety of types, and need not be limited to a ball-check valve.

Once the gas passes the check valve 8, it flows through a passage 5 formed in the body 3 until it enters into a space 9 adjacent to an adapter fitting 10 which is connected to the head space of the storage cylinder, where a top gaseous layer is present. In this way, the pressure build regulator 4 provides fluid at a controlled pressure to the storage cylinder's headspace, thus increasing pressure in the cylinder up to the pressure build regulator set point.

The adaptor fitting 10 may have a threaded connection 11 at one end and a bolted connection at an opposite end. The threaded connection 11 is configured to engage a top threaded connection of the storage cylinder, while the bolted connection is configured to engage the manifold 1. In one exemplary embodiment, the adapter fitting 10 is an NPT adapter, for example without limitation a ½″ NPT adapter fitting, with an o-ring face seal on its opposite side for connecting to the manifold 1. By employing this adapter 10, the user can thread and seal the adapter 10 onto the top of the storage cylinder, and then bolt the manifold 1 onto the adaptor 10.

Pressure differentials exist between the weight of the liquid coming in from the pressure build inlet 2 fitting and the pressure resident in the head space of the storage cylinder. A cylinder pressure gauge 6 is therefore provided to indicate the pressure in the storage cylinder. As previously noted, for an exemplary CO₂ cylinder, the normal operating pressure range can be from about 125-140 psig.

The manifold 1 may further include a final line inlet fitting 12 for receiving gaseous CO₂ from the storage cylinder. The inlet fitting 12 connects to a line that runs to the headspace of the storage cylinder. The CO₂ enters the final line inlet fitting 12 and then a final line regulator 14 where pressure is reduced to a given pressure. The gas may then exit the final line regulator 14 through a final line outlet fitting 16 for use in, for example a beverage dispensing system. The outlet pressure of the final line regulator 14 is indicated by the final line pressure gauge 18.

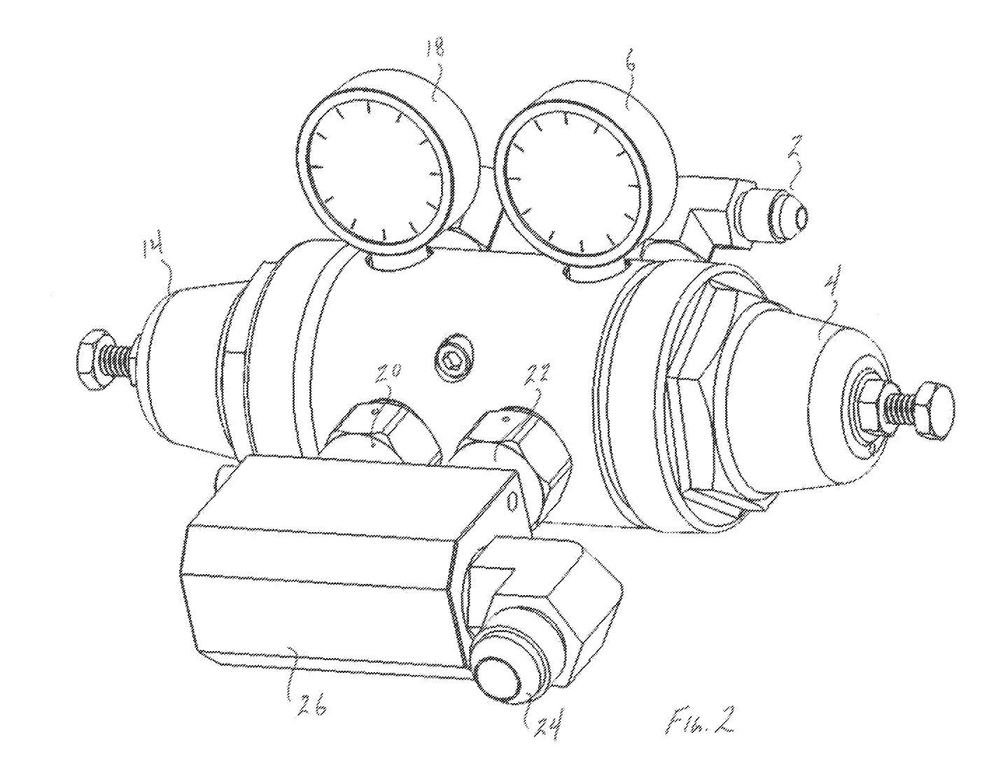

As shown in FIG. 2, the manifold 1 may include primary and secondary safety relief valves 20, 22. These two valves may be set at different pressures, thereby providing redundancy, to protect the storage cylinder from over-pressure and explosion. In one exemplary, non-limiting embodiment, the normal operating pressure range of a CO₂ storage cylinder is about 125 to 140 psig. The primary and secondary safety relief valves 20, 22 each may be set at a value above the high end of the normal operating pressure range.

The inlets of the relief valves 20, 22 are connected, via internal passageways in the valve body, to the space 9 (FIG. 3) adjacent to an adapter fitting 10 which is connected to the head space of the storage cylinder. The primary and secondary safety relief valves 20, 22 are connected to a common outlet hood 26. The hood 26 is connected to a directed outlet fitting 24 which itself may be connected to piping or tubing suitable for directing the effluent to a remote location for discharge. It will be appreciated that two relief valves are not required, and thus a configuration is contemplated in which only a single relief valve is provided. Further, in alternative embodiments, the primary and secondary safety relief valves 20, 22 may be connected to individual hoods and/or individual directed outlet fittings. Alternatively, it is not critical that a hood 26 or a directed outlet fitting 24 be provided, and thus the relief valves may discharge locally.

It will be appreciated that although the manifold 1 described in relation to FIGS. 1-3 is illustrated as including a pressure build inlet fitting 2, a final line inlet fitting 12 and a final line outlet fitting 16, such fittings are not critical to the invention. These connections may instead be simple female ports.

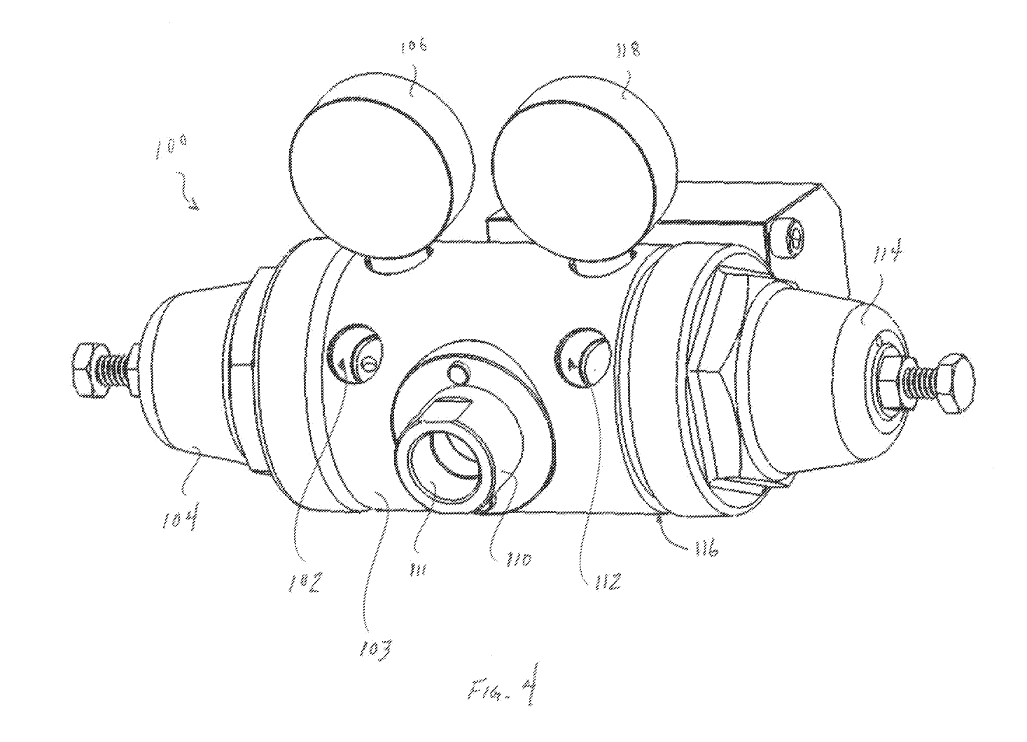

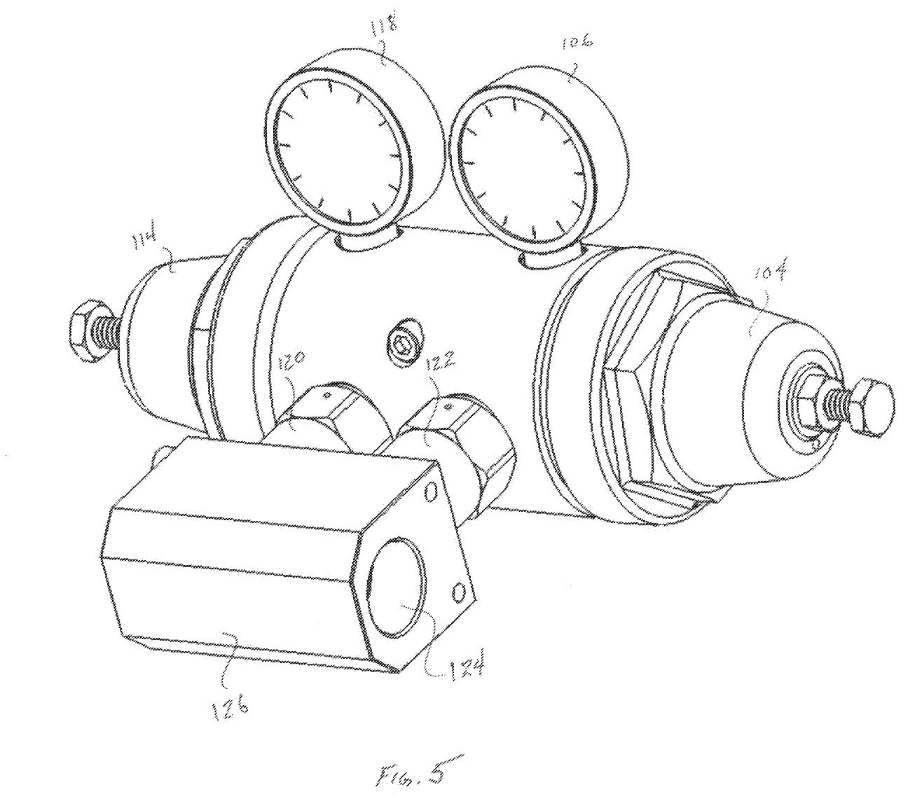

An exemplary manifold 100 incorporating such a female connection scheme is shown in FIGS. 4 and 5. As shown, manifold 100 includes a pressure build regulator 104 having an inlet port 102, an outlet adapter 110 with threads 111, and a line regulator 114 having a final line inlet port 112 and a final line outlet port 116. Safety relief valves 120, 122 similar to valves 20 and 22 described in relation to FIGS. 1-3 have outlets connected to hood 126 which terminates in a female port 124. Cylinder pressure gauge 106 and final line pressure gauge 118 are similar to gauges 6 and 18 described in relation to FIGS. 1-3. The remaining features of manifold 100 may also be the same as those described in relation to the embodiment of FIGS. 1-3.

In some embodiments, ports 102, 112, 115 and 124 comprise threaded female connections, such as female NPT connections. It will be appreciated, however, that these connections need not be threaded connections, but instead can be any of a variety of suitable connection types known in the art for liquid and gas delivery applications.

The cryogenic liquid cylinder pressure control manifold 1 is particularly useful as a CO₂ cryogenic liquid cylinder pressure control manifold for use in the beverage industry. As described, the manifold packages or unitizes together a plurality of valves required for liquid cylinder operation into one unit. This eliminates the need for labor to purchase and pipe together all of the needed valves and components separately, which eliminates typically high labor cost and/or longer assembly time; reduced throughput; potential leak paths; and more components at assembly. CO₂ cryogenic liquid cylinder pressure control manifolds may also be used for a variety of medical and industrial applications, and other like uses.

One valve manifold body may be designed to accommodate all the valve components needed. Connections between valves are preferably made through drilled passageways in the body. This eliminates most threaded connections, which are prone to leak. In this type of construction, the valve may be bolted on to the customer's system. The manifold can be configured to include additional fittings and pressure gages as desired. The manifold provides a regulator assembly that may be pre-set for immediate factory use.

The manifold may be used on several types of liquid or gaseous pressure vessels. It may also be used on liquid cylinders using other types of media (nitrogen, oxygen, argon etc). Other functional components such as shut-off valves, solenoid valves may be added, as desired, to address specific operational requirements.

From the foregoing description, it will be recognized by those skilled in the art that a manifold body designed to accommodate all the valve components required for a given functional need, eliminating most threaded connections which are prone to leaks, is particularly beneficial to the art.

While certain embodiments of the disclosure have been described, it is not intended that the disclosure be limited thereto. Rather, it is intended that the disclosure be as broad in scope as the art will allow and that the specification be read likewise. As such, the above description should not be construed as limiting, but merely as examples of particular embodiments. Those skilled in the art will envision other modifications within the scope and spirit of the claims appended hereto. Such alterations and changes to the described embodiments are possible without departing from the spirit and scope of the invention, as defined in the appended claims. Accordingly, it is intended that the present invention not be limited to the described embodiments, but that it has the full scope defined by the language of the following claims, and equivalents thereof.

What is claimed is:

1. A cryogenic fluid manifold, comprising:
a unitary body including first and second pressure regulators, each of said first and second pressure regulators having an inlet and an outlet; and
a storage cylinder adapter in fluid communication with the outlet of said first pressure regulator.

2. The cryogenic fluid manifold of claim 1, further comprising:
a pressure build inlet fitting in fluid communication with the inlet of said first pressure regulator;
a final line inlet fitting in fluid communication with an inlet of said second pressure regulator; and
a final line outlet fitting in fluid communication with an outlet of said second pressure regulator.

3. The cryogenic fluid manifold of claim 2, wherein at least one of the pressure build inlet fitting and the storage cylinder adapter connect to the first pressure regulator via a passageway formed in the unitary body.

4. The cryogenic fluid manifold of claim 2, wherein at least one of the line inlet fitting and the line outlet fitting connect to said second pressure regulator via a passageway formed in the unitary body.

5. The cryogenic fluid manifold of claim 1, wherein at least one of the inlet and the outlet of the first and second pressure regulators comprises a female threaded connection.

6. The cryogenic fluid manifold of claim 1, further comprising a check valve positioned between said first pressure regulator and said storage cylinder adapter.

7. The cryogenic fluid manifold of claim 6, wherein the check valve is oriented to allow fluid to flow from said first regulator to said storage cylinder adapter, and to prevent fluid from flowing from said storage cylinder adapter to said first pressure regulator.

8. The cryogenic fluid manifold of claim 1, wherein the first pressure regulator is a pressure build regulator and the second pressure regulator is a line regulator.

9. The cryogenic fluid manifold of claim 1, further comprising a first relief valve in fluid communication with at least one of the first pressure regulator inlet and the second pressure regulator inlet.

10. The cryogenic fluid manifold of claim 9, further comprising a second relief valve in fluid communication with at least one of the first pressure regulator inlet and the second pressure regulator inlet, the second relief valve having a set pressure that is different from a set pressure of the first relief valve.

11. The cryogenic fluid manifold of claim 1, further comprising first and second pressure gauges, said first pressure gauge configured to indicate pressure of at least one of the first pressure regulator inlet and the second pressure regulator inlet, the second pressure gauge configured to indicate pressure of the second pressure regulator outlet.

12. The cryogenic fluid manifold of claim 1, wherein the unitary body forms at least a portion of the first pressure regulator and at least a portion of the second pressure regulator.

13. The cryogenic fluid manifold of claim 1, wherein the storage cylinder adapter comprises an NPT connector at a first end and a bolted connection at a second end.

14. A method for processing a cryogenic composition, comprising the steps of:
providing a cryogenic fluid manifold comprising a unitary body having first and second pressure regulators;
receiving fluid from a cryogenic cylinder, regulating said received fluid using the first pressure regulator, and directing the fluid to a headspace region of the cryogenic cylinder to increase pressure in the cryogenic cylinder to a set point of the first pressure regulator; and
receiving gas from the headspace of the cryogenic cylinder, regulating said received gas using the second pressure regulator, and directing the regulated gas to a downstream line at a final regulated line pressure.

15. The method of claim 14, further comprising the step of preventing fluid from flowing from the cryogenic cylinder into an outlet of the first pressure regulator.

16. The method of claim 14, further comprising the steps of providing overpressure protection of said cryogenic cylinder using a first relief valve coupled to said manifold.

17. The method of claim 16, wherein the step of providing overpressure protection further comprises using a second relief valve coupled to said manifold, wherein a set point of said first relief valve is different from a set point of said second relief valve.

18. The method of claim 14, wherein the unitary body forms at least a portion of at least one of the first pressure regulator and the second pressure regulator.

19. A fluid manifold, comprising:
a unitary body including a pressure build regulator and a line pressure regulator;
a pressure build inlet fitting and a storage cylinder adapter in fluid communication with an inlet and an outlet, respectively, of said pressure build regulator;
a final line inlet fitting and a final line outlet fitting in fluid communication with an inlet and an outlet, respectively, of said line pressure regulator; and
a relief valve in fluid communication with at least one of the pressure build outlet fitting and the final line inlet fitting.

20. The fluid manifold of claim 19, further comprising a check valve positioned between said pressure build regulator and said storage cylinder adapter, said check valve oriented to allow fluid to flow from said pressure build regulator to said storage cylinder adapter, and to prevent fluid from flowing from said storage cylinder adapter to said pressure build regulator.

21. The fluid manifold of claim 19, wherein the pressure build inlet fitting and the storage cylinder adapter connect to the inlet and outlet of said pressure build regulator via respective passageways formed in the unitary body.

22. The fluid manifold of claim 19, wherein at least one of the line inlet fitting and the line outlet fitting connect to said line pressure regulator via a passageway formed in the unitary body.

23. The fluid manifold of claim 19, wherein the unitary body forms at least a portion of at least one of the pressure build regulator and the line pressure regulator.

24. The fluid manifold of claim 19, wherein the storage cylinder adapter comprises an NPT connector at a first end and a bolted connection at a second end, the NPT connector configured to engage a corresponding fitting of a storage cylinder and the bolted connection configured to engage a corresponding surface of said manifold.
